(19) United States
(12) Patent Application Publication
(10) Pub. No.: US 2015/0040734 A1
(43) Pub. Date: Feb. 12, 2015

(54) Stem-cutting Apparatus and Related Methods

(71) Applicant: Paul A. Harris, North Hampton, NH (US)

(72) Inventor: Paul A. Harris, North Hampton, NH (US)

(21) Appl. No.: 14/451,880

(22) Filed: Aug. 5, 2014

Related U.S. Application Data
(60) Provisional application No. 61/862,641, filed on Aug. 6, 2013.

(51) Int. Cl. A01G 3/00

(52) U.S. Cl. CPC A01G 3/00
USPC 83/23; 83/613; 83/168; 83/639.1; 83/72; 83/70; 83/13

(57) ABSTRACT

A powered stem-cutting apparatus includes a top plate having a hole positioned therein. An actuation device is positioned proximate to the top plate, wherein the actuation device is activated by an activation device to move an actuator. A blade is connected to the actuator, wherein the blade is movable along a cutting path, wherein the cutting path intersects an axis of the hole.

### CROSS REFERENCE TO RELATED APPLICATION

This application claims benefit of U.S. Provisional Application Ser. No. 61/862,641 entitled, “Stem-Cutting Apparatus and Related Methods” filed Aug. 6, 2013, the entire disclosure of which is incorporated herein by reference.

### FIELD OF THE DISCLOSURE

The present disclosure is generally related to the processing of agricultural materials and more particularly is related to a stem-cutting apparatus and related methods.

### BACKGROUND OF THE DISCLOSURE

Cut flowers and other desirable cut vegetation are sold throughout the country, by big-box stores, grocery chains and retail florists. One of the key desirable characteristics of cut flowers is that they remain pleasing to the eye for as long as possible. One of the most important variables in cut flower processing is the quality of the stem cut on the flowers. While the processing time of the flowers and the handling conditions are industry-wide issues, ensuring a quality cut of the flower stem is often a localized process, such as at a flower processing center or a retail setting.

Virtually all flowers sold around the world are cut three times before they reach the end user. They are typically cut by a worker using a chop saw, a band saw, a guillotine cutter, or hand snips. The quality of a cut on the stem is an important aspect in reducing spoilage of the flower, allowing the flower to remain fresh and in a sellable state to the end consumer. It is estimated that as much as 30% of floral products grown are not sold due to spoilage. A quality cut of the flower stem facilitates increased hydration, thereby extending flower life and reducing spoilage. Conventional stem-cutting devices often produce a poor quality stem cut, resulting in flowers that spoil quicker. Manual cutting devices crush or tear delicate stem capillaries, inhibiting their ability to take up water. Additionally, the use of the conventional cutting devices often results in worker injuries. Manual cutting of flower products means that workers are subjected to significant repetitive use of these tools, which often leaves them with repetitive stress injuries. Also, use of these conventional devices is also dangerous and workers can suffer accidental traumatic injuries, such as appendages being cut on the blade.

Thus, a heretofore unaddressed need exists in the industry to address the aforementioned deficiencies and inadequacies.

### SUMMARY OF THE DISCLOSURE

Embodiments of the present disclosure provide a system and method for a stem-cutting apparatus. Briefly described, in architecture, one embodiment of the system, among others, can be implemented as follows. A stem-cutting apparatus is disclosed. The stem-cutting apparatus includes a top plate having a hole positioned therein. An actuation device is positioned proximate to the top plate, wherein the actuation device is activated by an activation device to move an actuator. A blade is connected to the actuator, wherein the blade is movable along a cutting path, wherein the cutting path intersects an axis of the hole.

The present disclosure can also be viewed as providing a stem-cutting apparatus. Briefly described, in architecture, one embodiment of the apparatus, among others, can be implemented as follows. The stem-cutting apparatus includes a top plate having a hole positioned therein. A funnel is positioned within the hole and extends past a bottom surface of the top plate. A main block is contacting a lower edge of the funnel, the main blocking having a hole therein aligned substantially concentric with the funnel. An actuation device is affixed to the main block and has an actuator, wherein the actuator is movable between a retracted position and an extended position. A blade is connected to the actuator, wherein the blade is movable along a cutting path, wherein the cutting path intersects an axis of the funnel. A limiter plate is connected to the actuator, is positioned substantially parallel to the blade, and is spaced a predetermined distance from the blade, wherein the limiter plate is stationary relative to the blade, wherein the limiter plate has a limiter plate hole therein, wherein in the retracted position, the limiter plate intersects the axis of the funnel and in the extended position, the axis of the funnel is positioned within the limiter plate hole.

The present disclosure can also be viewed as providing a method of cutting stems of agricultural products. In this regard, one embodiment of such a method, among others, can be broadly summarized by the following steps: providing a stem-cutting apparatus having a funnel; placing at least one stem of an agricultural product within the funnel; contacting the at least one stem to a limiter plate, wherein the limiter plate is positioned beyond a lower edge of the funnel and in a position intersecting an axis of the funnel; and activating an actuation device having an actuator, thereby moving the blade along a cutting path intersecting the axis of the funnel to sever the at least one stem of the agricultural product, whereby the limiter plate moves with the actuator thereby remaining stationary relative to the limiter plate.

Other systems, methods, features, and advantages of the present disclosure will be or become apparent to one with skill in the art upon examination of the following drawings and detailed description. It is intended that all such additional systems, methods, features, and advantages be included within this description, be within the scope of the present disclosure, and be protected by the accompanying claims.

### BRIEF DESCRIPTION OF THE DRAWINGS

Many aspects of the disclosure can be better understood with reference to the following drawings. The components in the drawings are not necessarily to scale, emphasis instead being placed upon clearly illustrating the principles of the present disclosure. Moreover, in the drawings, like reference numerals designate corresponding parts throughout the several views.

FIG. 1 is a perspective view illustration of a stem-cutting apparatus, in accordance with a first exemplary embodiment of the present disclosure.

FIG. 2 is a cross-sectional illustration of a stem-cutting apparatus, in accordance with the first exemplary embodiment of the present disclosure.

FIG. 3 is a bottom view illustration of a stem-cutting apparatus, in accordance with the first exemplary embodiment of the present disclosure.

FIG. 4 is a perspective view illustration of the main block of a stem-cutting apparatus, in accordance with the first exemplary embodiment of the present disclosure.

FIG. 5 is a cross-sectional side view of the main block of a stem-cutting apparatus, in accordance with the first exemplary embodiment of the present disclosure

FIG. 6 is a perspective view illustration of the blade of a stem-cutting apparatus, in accordance with the first exemplary embodiment of the present disclosure.

FIG. 7 is a perspective view illustration of the cutting edge of the blade of a stem-cutting apparatus, in accordance with the first exemplary embodiment of the present disclosure.

FIG. 8 is a perspective view illustration of a limiter plate of a stem-cutting apparatus, in accordance with the first exemplary embodiment of the present disclosure.

FIG. 9 is a perspective view illustration of a limiter plate guide of a stem-cutting apparatus, in accordance with the first exemplary embodiment of the present disclosure.

FIG. 10 is a perspective view illustration of the limiter plate, the blade, the main block, the limiter plate guide, and the actuation device of a stem-cutting apparatus, in accordance with the first exemplary embodiment of the present disclosure.

FIG. 11 is a side view illustration of a stem-cutting apparatus, in accordance with the first exemplary embodiment of the present disclosure.

FIG. 12 is a cross-sectional view illustration of a wiper and sanitizer/disinfectant sponge of a stem-cutting apparatus, in accordance with the first exemplary embodiment of the present disclosure.

FIG. 13 is a perspective view illustration of a pneumatically-driven stem-cutting apparatus, in accordance with a second exemplary embodiment of the present disclosure.

FIG. 14 is a bottom view illustration of an electromechanically-driven stem-cutting apparatus, in accordance with a third exemplary embodiment of the present disclosure.

FIG. 15 is a side view illustration of an electromechanically-driven stem-cutting apparatus, in accordance with the third exemplary embodiment of the present disclosure.

FIG. 16 is a flowchart illustrating a method of making the cutting vegetation with a stem-cutting apparatus in accordance with a fourth exemplary embodiment of the disclosure.

### DETAILED DESCRIPTION

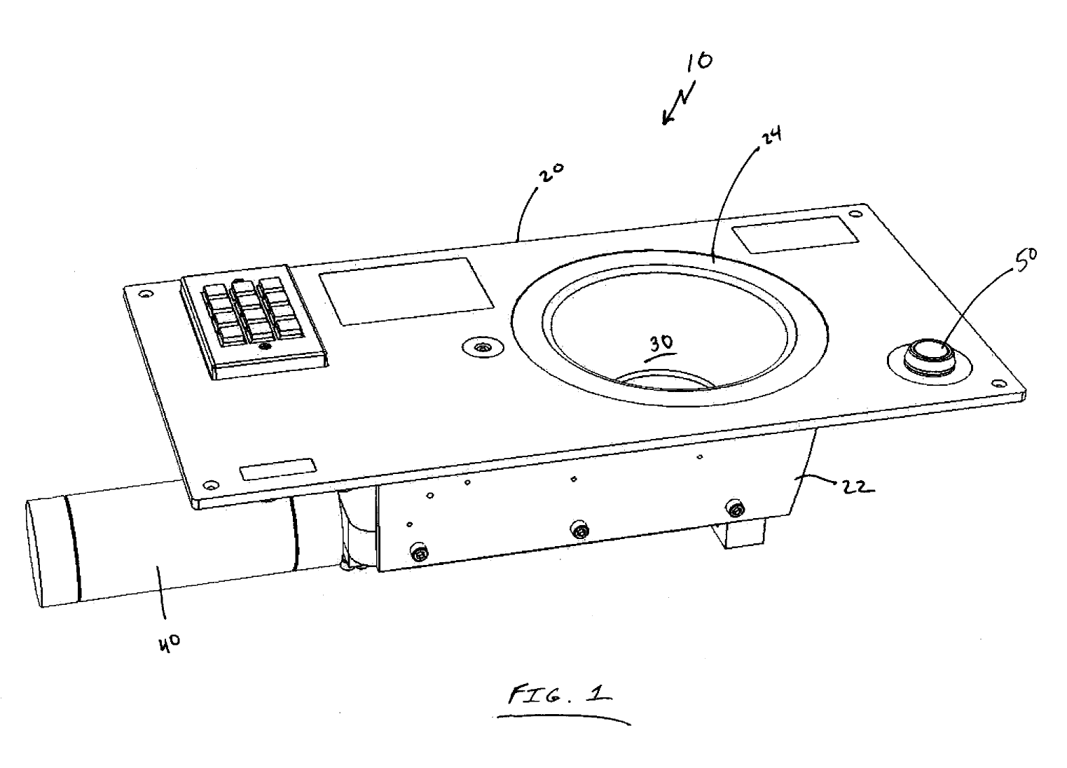

FIG. 1 is a perspective view illustration of a stem-cutting apparatus 10, in accordance with a first exemplary embodiment of the present disclosure. The stem-cutting apparatus 10, which may be referred to herein as ‘apparatus 10’ may be used within the floral industry or within any other industry requiring cutting of stems, plants, or other vegetation. In particular, the apparatus 10 may be beneficial in industrial, commercial, or retail settings, where it may be necessary to trim the stems of flowers before display or customer purchase for the purposes of improved hydration of fresh produce, aesthetics, or any other purpose. While the present disclosure may be described with respect to flower stems, it is noted that the apparatus 10 may be used to cut or trim any type or variety of vegetation and/or non-vegetation articles.

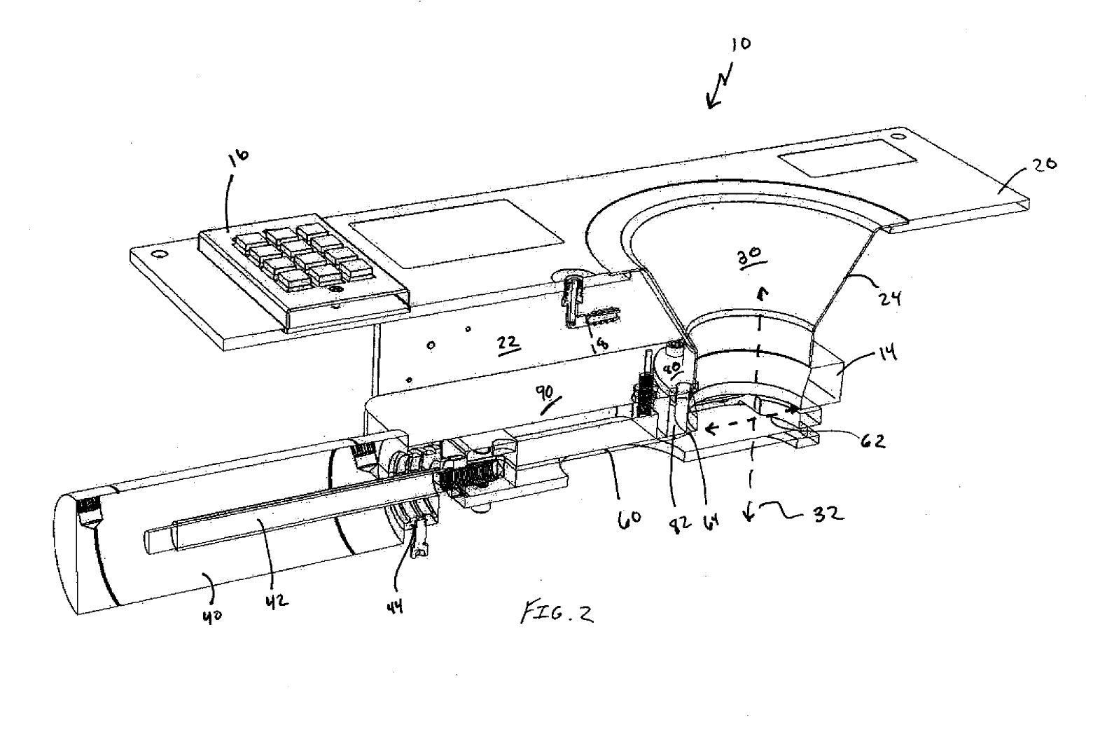

FIG. 2 is a cross-sectional illustration of a stem-cutting apparatus 10, in accordance with the first exemplary embodiment of the present disclosure. Relative to FIGS. 1 and 2, the apparatus 10 includes a top plate 20 having a hole 30 positioned therein. An actuation device 40 is positioned proximate to the top plate 20, wherein the actuation device 40 is activated by an activation device 50 to move an actuator 42. A blade 60 is connected to the actuator 42, wherein the blade 60 is movable along a cutting path (indicated by the broken arrow, 62), wherein the cutting path 62 intersects an axis 32 of the hole 30.

The top plate 20 may form the general body of the apparatus 10 and support other components of the apparatus 10, including a funnel 24. The top plate 20 may be a substantially planar structure having an upper and lower surface, and may include one or more sidewalls 22 extending from the lower surface in a substantially perpendicular orientation. The sidewalls 22 may be used to affix other components of the apparatus 10 to the top plate 20. The hole 30 formed in the top plate 20 may be formed through an entire thickness of the top plate 30, such that the funnel 24 can be placed within the hole 30. It is noted that the hole 30 may have a variety of shapes, all of which are considered within the scope of the present disclosure.

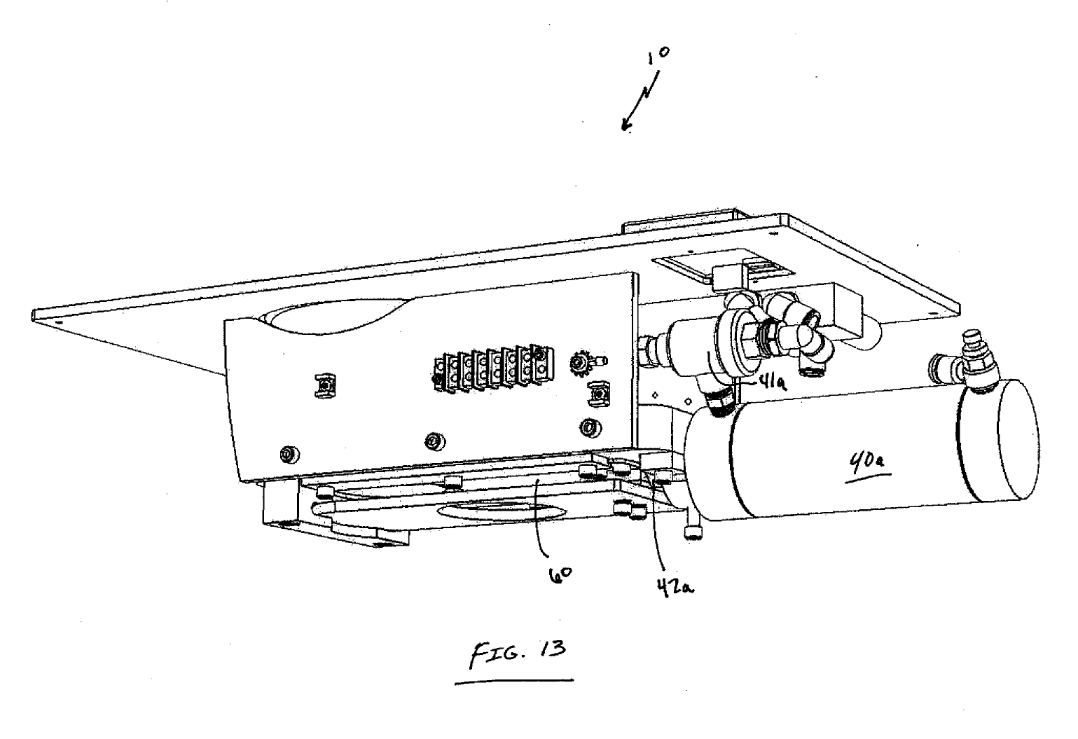

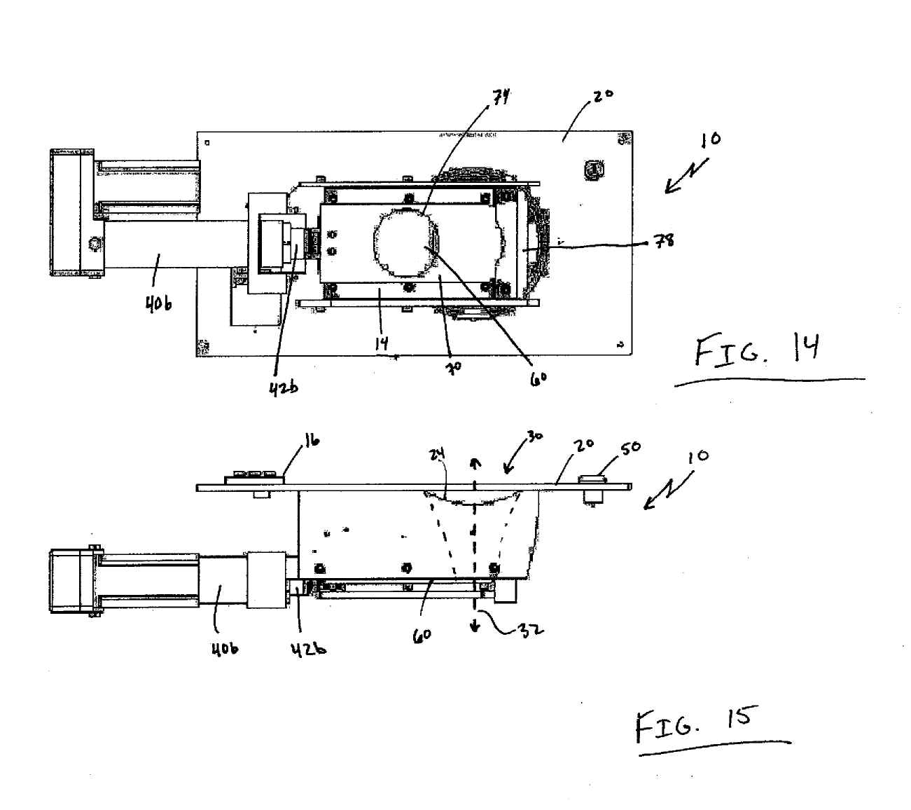

The actuation device 40 may be positioned proximate to the top plate 20, such as below the top plate 20 and connected directly or indirectly to the sidewalls 22. The actuation device 40 is activated by an activation device 50 which can be activated by a user of the apparatus 10. The activation device 50 may include a variety of activating or switching devices, such as one utilizing a depressible button, as is illustrated in FIG. 1. Activation of the activation device 50 may engage the actuation device 40 to move the actuator 42 along a substantially linear path, such as along an axis of the actuator 42. The actuation device 40 may include a variety of machines and devices powered in a number of ways. For example, the actuation device 40 may be pneumatically-powered device operating under compressed gas, an example of which is described relative to FIG. 13, or the actuation device 40 may be powered with an electromechanical device, as is described relative to FIGS. 14-15. The actuation device 40 may also be powered by other means, so long as they are capable of moving the actuator 42. The activation device 50, illustrated as a depressible button, is connected to an electrical circuit which is in communication with the actuation device 40. The electrical circuit may also be in communication with other components, such as a computer or control module which may enact various safety features for ensuring safe operation of the apparatus 10. It is noted that the activation device 50 may include other types of depressible components, such as a foot pedal.

Among other components, a blade 60 is connected to the actuator 42 and is movable with the actuation 42 upon engagement of the actuation device 40. Accordingly, the blade 60 is movable along a cutting path (indicated by the broken arrow, 62) which may commonly be at least partially aligned with the axis of the actuator 42. The cutting path 62 intersects an axis 32 of the hole 30, such that when the blade 60 moves along the cutting path 62, it will contact (and sever) any objects which are positioned at the intersection of the cutting path 62 and the axis 32 of the hole 30. When a user activates the activation device 50, the actuation device 40 engages to swiftly move the actuator 42 with blade 60 attached along the cutting path 62. Accordingly, the blade 60 can effectively sever the stems of flowers or other vegetation when they are inserted into the funnel 24 and down through hole 30, with the ends of the stems positioned below the plane of the cutting path 62. Specifically, a cutting edge 64 of the blade 60 may make contact with the stems of the flowers and sever them. Once the cut is complete, the actuator 42 withdraws the blade 60 to the retracted positioned, shown in FIG. 2.

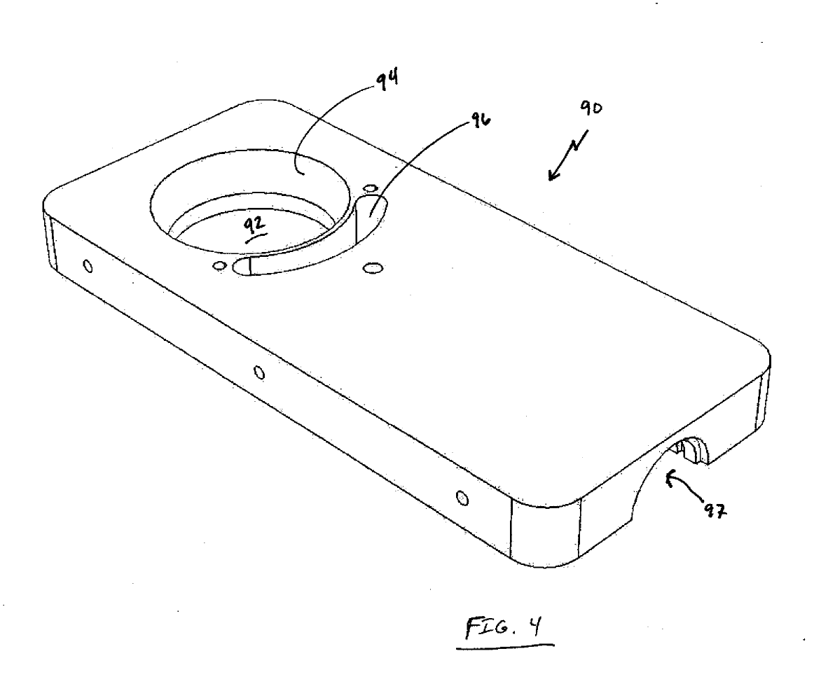

As is shown in FIGS. 1-2, the apparatus 10 may include a plurality of other components and features, many of which are described in greater detail relative to FIGS. 4-15. Generally, the apparatus 10 may include a funnel 24 positioned at least partially within the top plate 20 and substantially concentric with the hole 30. The funnel 24 may comprise any type of feed chute having any size and any shape. A main block 90 may be positioned along a lower edge of the funnel 24, wherein the actuation device 40 may be connected to the main block 90. A limiter plate 70 may be positioned substantially parallel to the blade 60 and spaced a predetermined distance from the blade 60, such that the blade 60 is positioned between the limiter plate 70 and the main block 90. A wiper plate 80 having a wiper and sanitizer/disinfectant sponge 82 may be positioned in contact with a top surface of the blade 60 such that it can wipe the top surface of the blade 60 when the blade 60 is moved. A sensor 18 may also be included to provide sensing capabilities relative to objects within the funnel 24.

The funnel 24 may be positioned at least partially within the hole 30 through the top plate 20. The funnel 24 may have an upper edge substantially aligned with the top surface of the top plate 20, and a lower edge that is positioned below the top plate 20, terminating before the position of the cutting path 62. While the specific dimensions of the funnel 24 may vary depending on the design and intended use of the apparatus 10, the upper edge of the funnel 24 will have a larger radius than the lower edge of the funnel 24, thereby allowing stems and other items to be compressed together as then are pushed into the funnel 24. These angled sides or flared edges of the funnel 24 may accommodate optimal cutting action by positioning the stems in to a compact bunch. The upper edge of funnel 24 may be sized larger than the diameter of the hole 30, thereby allowing the upper edge to be retained on the top plate 20 while the body of the funnel 24 extends below the top plate 20.

The main block 90 may act as a centralized structure for connection of other components of the apparatus 10. For example, the funnel 24 may be positioned in contact or attached to a main block 90 at the lower edge of the funnel 24. As is shown in FIG. 2, the actuation device 40 may be connected to the main block 90 with a clamp 44, or another fastener. At the end of the actuator 42, a fastener may be used to affix the actuator 42 to both the blade 60 and the limiter plate 70. During movement, the actuator 42 carrying the blade 60 and the limiter plate 70 may move along at least a portion of the length of the main block 90. The wiper plate 80 having the wiper and sanitizer/disinfectant sponge 82 may also be connected to the main block 90 along the exterior of the hole 30. The wiper and sanitizer/disinfectant sponge 82 may extend through the main block 90 such that it can contact the top surface of the blade 60 and wipe it clean and sanitize each time the blade 60 is moved along the cutting path 62.

The apparatus 10 may include a variety of other components and features. For example, the apparatus 10 may include one or more sensors 18 for determining if cutting hazards are present within the funnel 24 or cutting path 62. For example, the sensor 18 may include a sensor which is capable of sensing a heat signature within the funnel or the cutting path 62. Accordingly, a sensor may be capable of determining whether a user's hand is positioned within the funnel 24. If the sensor senses heat, it may communicate a signal to the keypad 16 or another component of the apparatus 10 to prevent movement of the blade 60 or fully lock the apparatus 10 from use. Accordingly, the sensor may prevent many accidents and injuries. Another type of sensor 18 may include a metal sensor which is capable of sensing a metallic material within the funnel 24 or in the cutting path 62. The metal sensor may include Gauss coils and appropriate circuitry positioned around the outside of the funnel 24 for detection of trace amounts of metal, such as metal threads, strips, or similar structures that are embedded or woven within gloves. Accordingly, if metal is detected, the metal sensor may communicate a signal to the keypad 16 or another component of the apparatus 10 to prevent movement of the blade 60 or fully lock the apparatus 10 from use.

Other sensors may also be included with the apparatus 10, including a blade movement sensor which can sense movement and/or position of the blade 60. For example, the sensors may determine that a blade 60 is in motion and that a heat signature is sensed within the cutting path 62, and subsequently control the blade 60 to stop its motion. The ability to stop the blade 60 from movement mid-sequence and/or reverse the blade 60 to a retracted position if a heated object is sensed or if other situations are sensed where injury may be available only with certain embodiments of the apparatus 10.

The apparatus 10 may also include an operational control system which may control a movement of the blade, an activation of the actuation device 40, usage and/or lockdown of the apparatus, and other aspects of use of the apparatus 10. The operational control system may include the sensors 18 discussed herein in combination with other control devices, such as computerized hardware, software, user input devices, indicators, alarms, and appropriate circuitry to enable full functionality. The operational control system may include the keypad 16 which is in communication with the actuation device 40, such that the keypad 16 provides a barrier to activation of the actuation device 40. The keypad 16 may, for example, require an input passcode which is entered on the keypad to unlock activation of the actuation device, i.e., to gain access to using the apparatus 10, thereby restricting use of the apparatus 10 to pre-selected users, namely those who have been properly trained and authorized. Similarly, the operational control system may include a near-field communication (NFC) circuit that requires detection of a NFC signal to unlock activation of the actuation device.

Another feature that may be included is a time-out delay switch which is in communication with the actuation device 40. After a predetermined period of time of inactivity of the actuation device 40, the time-out delay switch may lock activation of the actuation device 40. Thus, a user may be required to re-input a code or PIN after the predetermined period of inactivity has occurred. An additional feature may include a proximity sensor in communication with the actuation device 40, where the proximity sensor unlocks operation of the actuation device 40 upon a predetermined signal sensed within a predetermined radius of the proximity sensor. For example, a qualified user with a key card on his/her person may be sensed by the proximity sensor when the user is within a defined radius of the proximity sensor, such as 5 feet. When the user moves beyond the predetermined radius, the proximity sensor may detect the absence of the user's location within the predetermined radius and subsequently render the apparatus 10 inoperable. It is noted that these components may be in direct communication with the actuation device 40 or they may be in indirect communication with the actuation device 40, such that communication is routed, controlled, or otherwise influenced by another component of the operational control system.

It is noted that the various components within the apparatus 10 may be formed to provide durable, reliable, and long-term use of the apparatus 10. For example, components of the apparatus 10 may be formed from industry-tested materials such as metals, plastics, or other substantially rigid and durable materials. The apparatus 10 may also be installed within a cabinet or workstation (not shown), which may be movable and on casters, constructed from wood, stainless steel or other durable material. The top plate 20 may be installed such that the top surface is substantially co-planar with a top surface of the cabinet or workstation and the hole 30 extends into an interior portion of the cabinet or workstation.

Through experimentation, it has been discovered that the quality of the stem cut with the apparatus 10 meets or exceeds the quality of a hand cut, making flowers last longer. Additionally, the apparatus 10 provides significant time savings and safety benefits over traditional manual devices. From a quality standpoint, the actuation device 40 and actuator 42 may provide reliable operation of the blade 60, and importantly, provide movement of the blade 60 with a force and speed that ensures a quality stem cut. From a safety standpoint, engagement of the activation device 50 to move the blade 60, thereby preventing injury-causing repetitive motions of the user, offers significant benefits over conventional devices. And, beyond mere injuries from repetitive motion, the apparatus 10 includes many safety features that allow for efficient stem cutting without subjecting the user to the injuries of accidentally contacting the blade 60.

In addition to the components of the apparatus 10 disclosed herein, other components not specifically discussed may be included with the apparatus 10. These components include, for example, a power supply, a keypad wiring harness, gaskets, a switch cable assembly, a proximity sensor cable assembly, a solenoid, a solenoid cable assembly, and various holders and fasteners. The use of any of these components with the apparatus 10 is considered to be within the scope of the present disclosure.

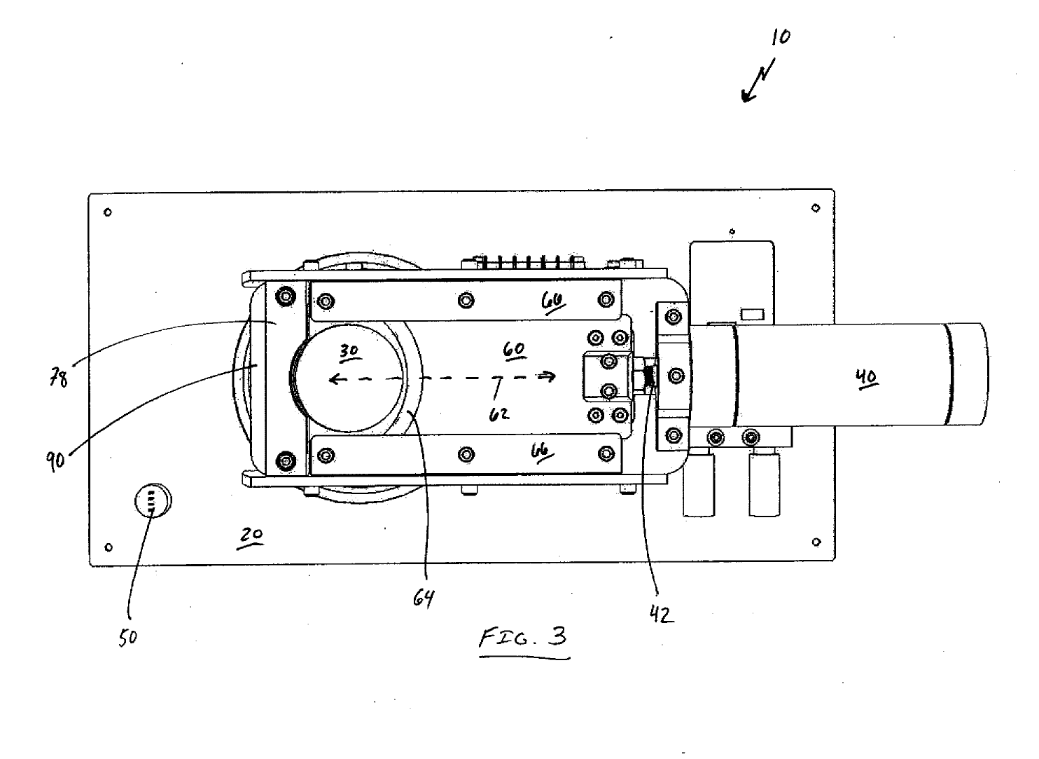

FIG. 3 is a bottom-view illustration of a stem-cutting apparatus 10, in accordance with the first exemplary embodiment of the present disclosure. The limiter plate 70 (FIGS. 1-2) is not shown in FIG. 3, to provide clarity in disclosure of the components of the apparatus 10 that are positioned proximate to the limiter plate 70. As can be seen readily from FIG. 3, the blade 60 may be connected to the actuator 42 with threaded fasteners, thereby allowing for removal and replacement of the blade 60. The blade 60 may rest within a plurality of side rails 66 which are fastened to a main block 90 and positioned parallel to the cutting path 62. The main block 90 may be connected to the top plate 20 and located between the blade 60 and the top plate 20.

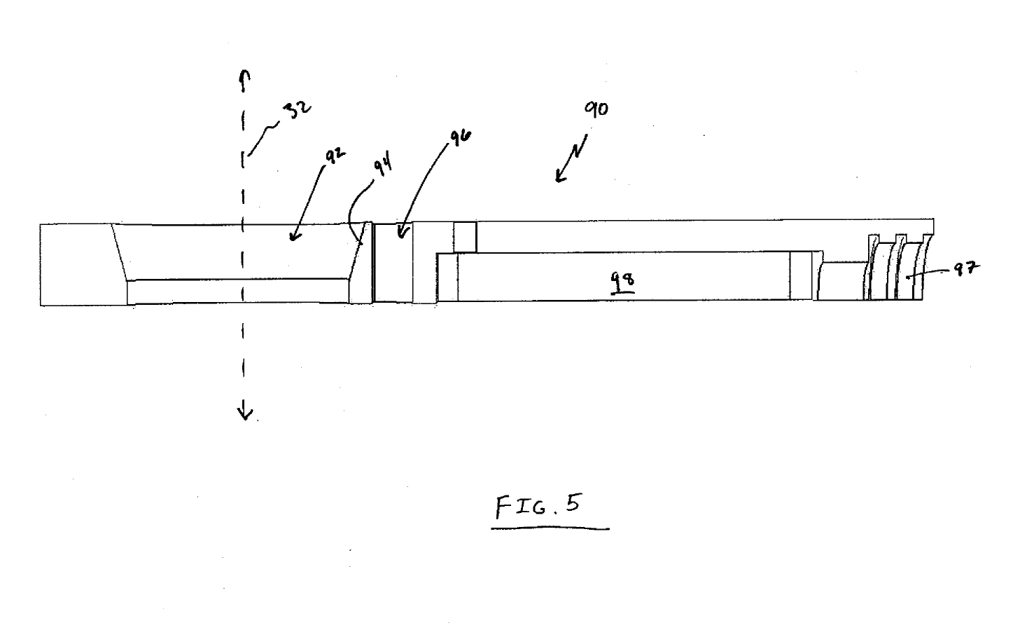

FIG. 4 is a perspective view illustration of the main block 90 of a stem-cutting apparatus 10, in accordance with the first exemplary embodiment of the present disclosure. FIG. 5 is a cross-sectional side view of the main block 90 of a stem-cutting apparatus 10, in accordance with the first exemplary embodiment of the present disclosure. The main block 90 may have a hole 92 therein which may be coaxial with the axis 32 of the hole 30 of the top plate 20 (FIGS. 1-2). The hole 92 may include a funneled portion 94 which generally defines the hole 92 within the main block. The funneled portion 94 includes angled or tapered sidewalls which assist with funneling the stems into a compact bunch for cutting. The main block 90 may also include an aperture 96 for housing the wiper and sanitizer/disinfectant sponge 82 (FIG. 2) positioned proximate to the hole 92. The aperture 96 may have a curved shape, thereby allowing the wiper sponge 82 to be positioned along the curved side of the hole 92, as is best shown in FIG. 4. The main block 90 may also include a cut-away 97 and a cavity 98 which may facilitate movement of the actuator 42 proximate to the main block 90 without contacting the main block 90. For example, the end of the actuator 42 may be movable through the cut-away 97 and may traverse along the length of the cavity 98 between extensions and retractions of the actuator 42.

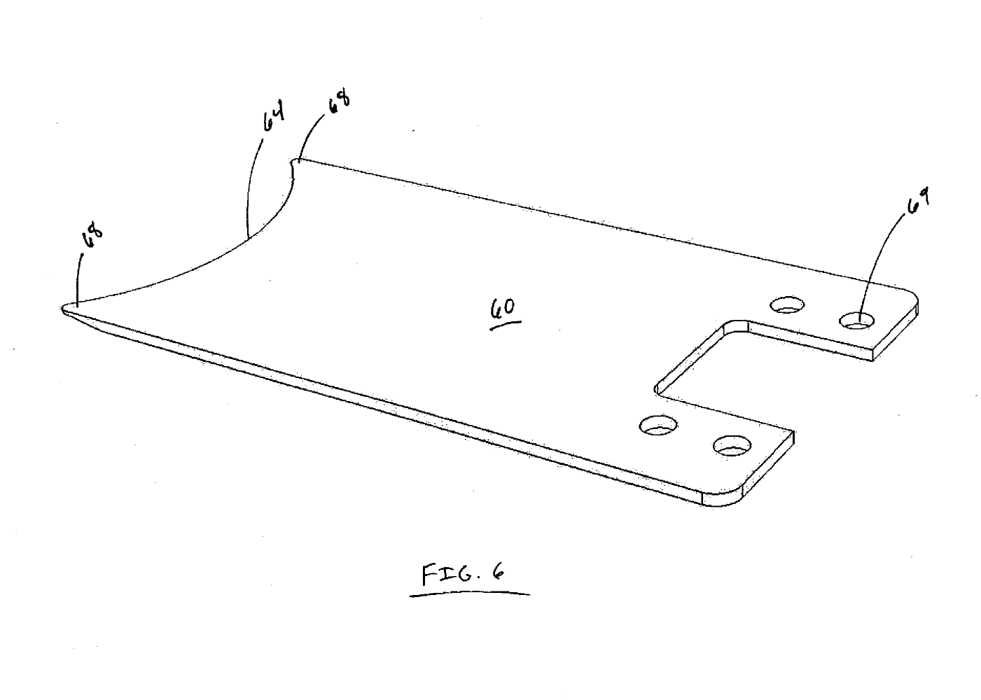

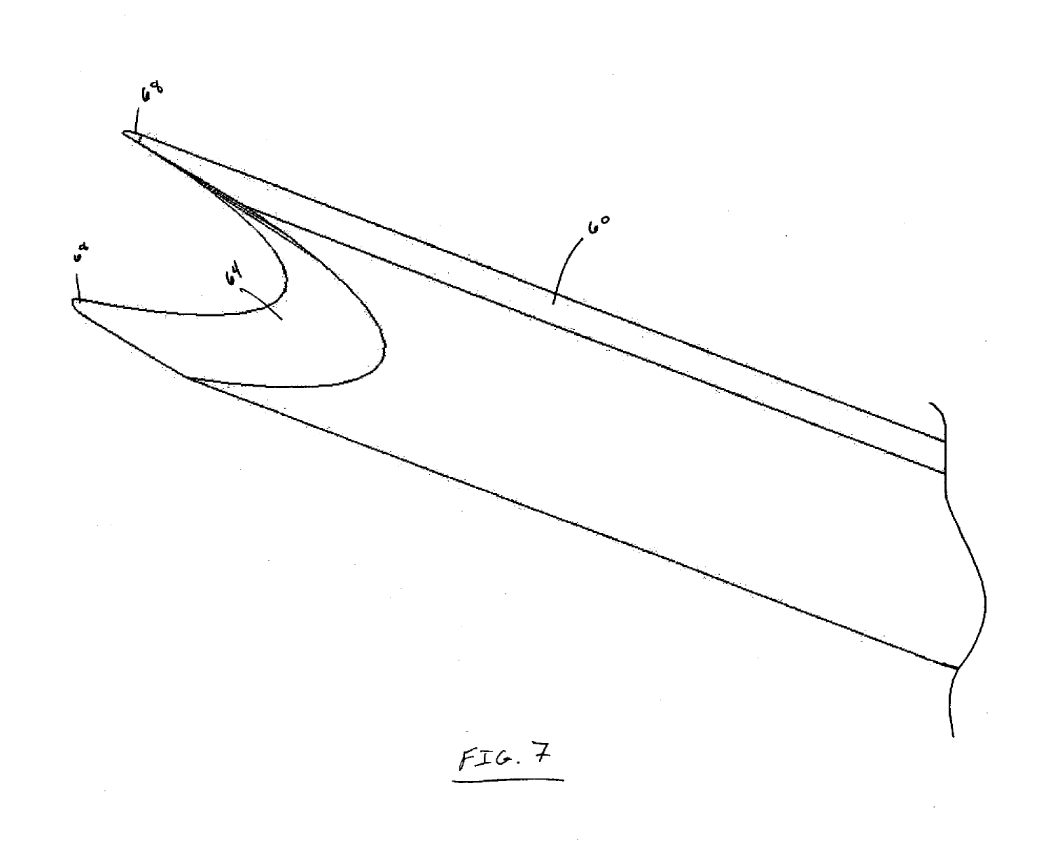

FIG. 6 is a perspective view illustration of the blade 60 of a stem-cutting apparatus 10, in accordance with the first exemplary embodiment of the present disclosure. FIG. 7 is a perspective view illustration of the cutting edge 64 of the blade 60 of a stem-cutting apparatus 10, in accordance with the first exemplary embodiment of the present disclosure. With reference to FIGS. 6-7, the blade 60 may be a substantially planar structure which is formed from a variety of metallic or non-metallic materials conventionally used for forming cutting structures, for example, stainless steel or ceramics. The blade 60 may have a specifically-shaped cutting edge 64, such as one having a concave curvature with blade tips 68 on terminating ends of the cutting edge 64. The cutting edge 64 may have specific dimensions and include features such as dual bevels. For example, cutting edge 64 may include specific multiple-bevel angles for precise cutting action various forms of vegetation. The blade 60 may be coated with a corrosion-proof blade coating applied to an exterior surface of the blade 60 to prevent damage. At an opposing side on the blade 60 from the cutting edge 64, the blade 60 may include holes 69 for securing the blade 60 to the end of the actuator 42 (FIGS. 1-2) using fasteners.

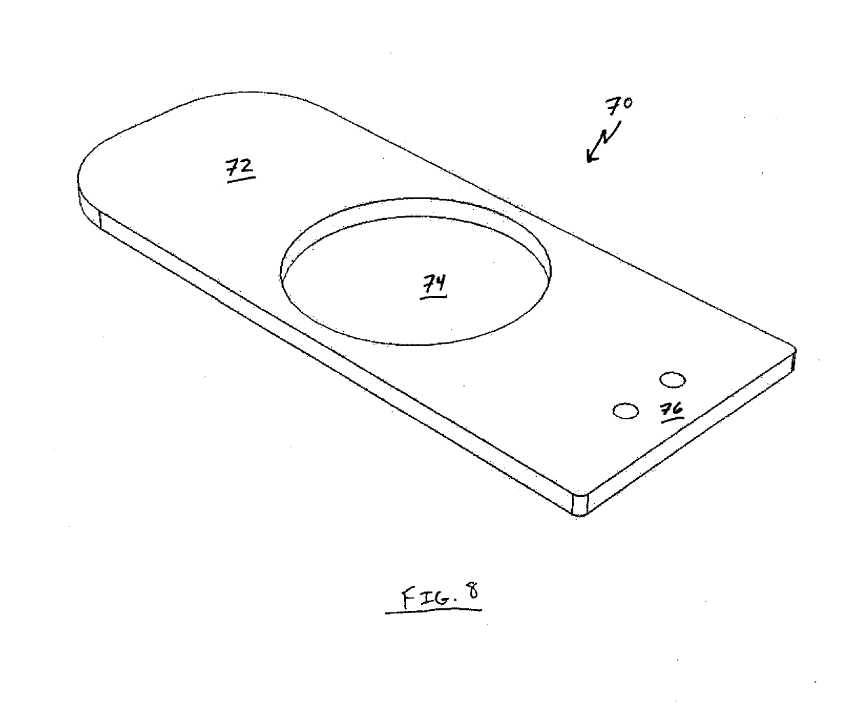

FIG. 8 is a perspective view illustration of a limiter plate 70 of a stem-cutting apparatus 10, in accordance with the first exemplary embodiment of the present disclosure. As can be seen in FIG. 8, the limiter plate 70 includes a contact portion 72 for contacting the flower stems when they are inserted through the hole 30 of the top plate 20 and the funnel 24 (FIGS. 1-2), a fastening portion 76 for connecting the limiter plate 70 to the actuator 42 (FIG. 2), and a limiter plate hole 74 positioned between the contact portion 72 and the fastening portion 76. While the specific dimensions of the limiter plate 70 may vary, it may be preferable for the size of the limiter plate hole 74 to substantially match the hole 30 of the top plate 20 (FIGS. 1-2) and the hole 92 of the main block 90 (FIG. 4), thereby allowing for efficient clearance of severed stem pieces.

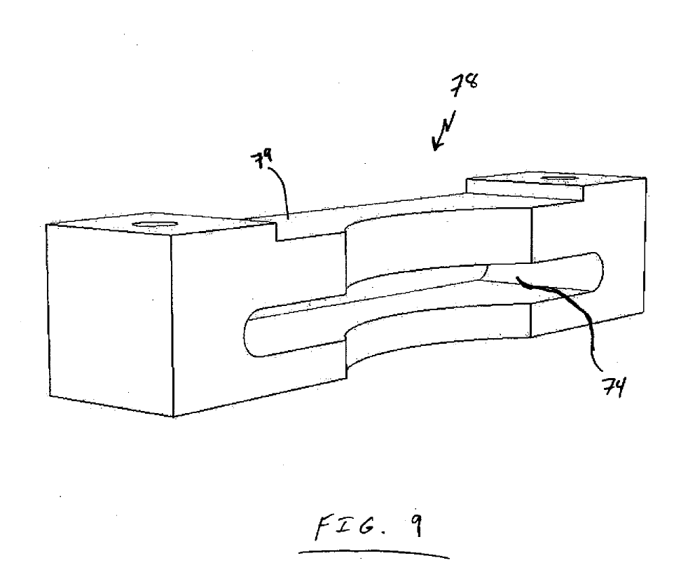

FIG. 9 is a perspective view illustration of a limiter plate guide 78 of a stem-cutting apparatus 10, in accordance with the first exemplary embodiment of the present disclosure. The limiter plate guide 78 may be used to guide the limiter plate 70 (FIG. 8) when it is moved during an extension and retraction of the actuator 42 (FIGS. 1-2). The limiter plate guide 78 includes a limiter plate slot 74 which is positioned through the limiter plate guide 78 and is sized to receive the limiter plate 70. At the top of the limiter plate guide 78, a stepped-down surface 79 may be included to allow the blade 60 (FIG. 2) to move through the limiter plate guide 78.

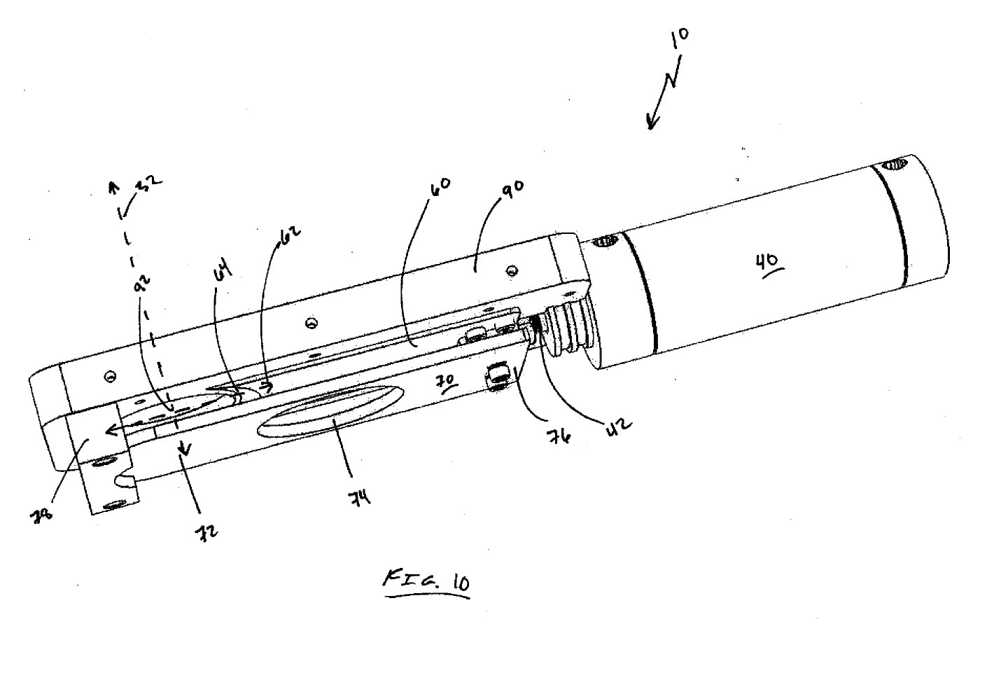

FIG. 10 is a perspective view illustration of the limiter plate 70, the blade 60, the main block 90, the limiter plate guide 78, and the actuation device 40 of a stem-cutting apparatus 10, in accordance with the first exemplary embodiment of the present disclosure. The limiter plate 70 may be positioned parallel to the blade 60 in a positioned below the blade 60, i.e., such that the blade 60 is positioned between the limiter plate 70 and the main block 90. The limiter plate 70 is connected to the end of the actuator 42 with threaded fasteners secured through the fastening portion 76 of the limiter plate 70, and the blade 60 is secured to the end of the actuator 42 with threaded fasteners secured through the holes within the rear end of the blade 60. The limiter plate 70 is movable with the blade 60, such that when the blade 60 is moved along the cutting path 62, the trim plate limiter 70 is moved parallel to the cutting path 62. Thus, the limiter plate 70 and the blade 60 are movable together on the actuator 42, however they are stationary relative to one.

Relative to FIGS. 1-2 and 10, when the blade 60 is in the retracted position, shown in FIG. 9, the contact portion 72 of the limiter plate 70 is positioned over the hole 30 and intersecting the axis 32 of the hole 30, such that any flower stems will contact the contact portion 72 when they are inserted into the hole 30. In this position, the blade 60 is located substantially overlaying or covering the limiter plate hole 74 of the limiter plate 70. The distance between the contact portion 72 and the blade 60 may control the stem cut length, which may commonly be 0.5 inches, but may vary. As the blade 60 is moved along the cut path 62 to cut the flower stems, the limiter plate hole 74 of the limiter plate 70 is moved to align with the hole 30. Thus, once the blade 60 has fully severed the flower stems, the limiter plate hole 74 is substantially fully aligned with the hole 30, which allows the trimmed stem pieces to fall through the limiter plate hole 74 and away from the apparatus 10 and indeed be wiped clean by the lower edge of limiter plate guide 78. A waste bin or container positioned below the hole 30 may be used to catch the trimmed pieces.

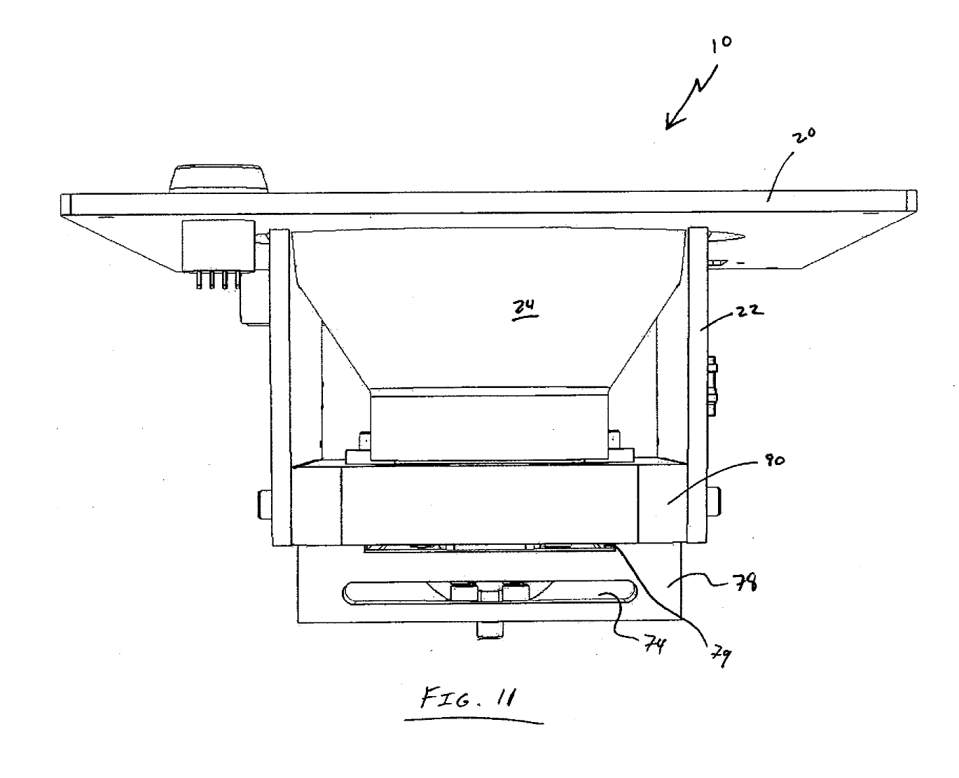

FIG. 11 is a side view illustration of a stem-cutting apparatus 10, in accordance with the first exemplary embodiment of the present disclosure. In particular, FIG. 11 depicts the trim plate limiter guide 78 secured to the main block 90, which is secured to the sidewalls 22 of the top plate 20. The limiter plate slot 74 and stepped-down surface 79 are positioned substantially aligned with the relative positioning of the blade 60 and the limiter plate 70 (FIG. 10), and the limiter plate slot 74 and stepped-down surface 79 are sized to substantially match the cross-sectional dimensions of the limiter plate 70 and the blade 60, respectively. During movement of the blade 60 and limiter plate 70, the limiter plate slot 74 may receive the contact portion 72 of the limiter plate 70 (FIG. 10) when the blade 60 is moved along the cutting path 62, thereby stabilizing the limiter plate 70.

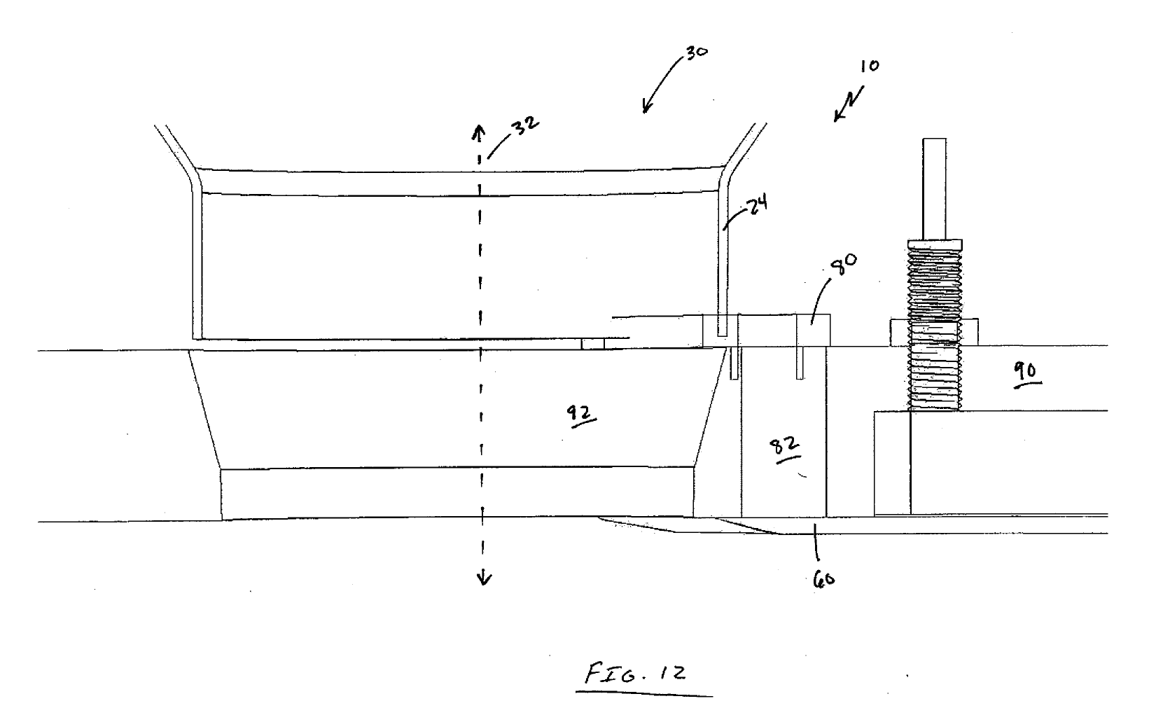

FIG. 12 is a cross-sectional view illustration of a wiper and sanitizer/disinfectant sponge 82 of a stem-cutting apparatus 10, in accordance with the first exemplary embodiment of the present disclosure. A wiper plate 80 and wiper and sanitizer/disinfectant sponge 82 may be included to clean and/or sanitize the blade 60. The wiper plate 80 may be connected to the main block 90 along the exterior of the hole 92, which is aligned with the funnel 24 and the hole 30 having axis 32. The wiper and sanitizer/disinfectant sponge 82 may be connected to the wiper plate 80 and positioned extending through the main block 90. The wiper and sanitizer/disinfectant sponge 82 may contact the top of the blade 60 and wipe it clean each time the blade 60 is moved along the cutting path. The wiper and sanitizer/disinfectant sponge 82 may also be saturated with sanitizing solution to sanitize the blade 60, thereby preventing contamination between the bunches of flower stems that are cut. A bottle of sanitizing solution (not shown) may be fluidly connected to the wiper and sanitizer/disinfectant sponge 82 to ensure continual moistening with the sanitizing solution.

FIG. 13 is a perspective view illustration of a pneumatically-driven stem-cutting apparatus 10, in accordance with a second exemplary embodiment of the present disclosure. The second exemplary embodiment may be substantially similar to the first exemplary embodiment described relative to FIGS. 1-12, and may include any of the components, features, or functions described relative to FIGS. 1-12, all of which are considered within the scope of the second exemplary embodiment of the present disclosure.

Compared to the first exemplary embodiment, the apparatus 10 of the second exemplary embodiment may have an actuation device 40 that is powered by pneumatic means, such as a quantity of compressed gas that is releasable upon command. When a pneumatic actuation device 40a is used, it is advantageous for the apparatus 10 to include fittings on the pneumatic actuation device 40a (pneumatic cylinder) to optimize the cutting action of the blade 60 and extend the life of the actuator 42a. Accordingly, the apparatus 10 may include various piping for a quick exhaust system 41a and a return flow control of the compressed gas. The pneumatic actuation device 40a may still be activated by an activation device 50 (FIG. 1), which optimally controls the release of pressurized gas using electronic means. For example, the activation device 50 may include a depressible button, which when pressed, connects an electrical circuit which is in communication with the pneumatic actuation device 40a, whereby a solenoid valve is momentarily opened to allow for a burst of compressed gas. The compressed gas may move the actuator 42a to move the blade 60, as described relative to the first exemplary embodiment.

FIG. 14 is a bottom view illustration of an electromechanically-driven stem-cutting apparatus 10, in accordance with a third exemplary embodiment of the present disclosure. FIG. 15 is a side view illustration of an electromechanically-driven stem-cutting apparatus 10, in accordance with a third exemplary embodiment of the present disclosure. The third exemplary embodiment may be substantially similar to the first exemplary embodiment described relative to FIGS. 1-12, and may include any of the components, features, or functions described relative to FIGS. 1-12, all of which are considered within the scope of the third exemplary embodiment of the present disclosure.

The stem-cutting apparatus 10 may include an electromechanically-driven actuation device 40b which drives a linear actuator 42b. The electromechanically-driven actuation device 40b may include a servomotor which is activated by an activation device 50 to move the linear actuator 42b. As described relative to the first exemplary embodiment, a blade 60 is connected to the main block 90, which in turn is connected to the linear actuator 42b and is movable along a cutting path when the linear actuator 42b is moved by the electromechanically-driven actuation device 40b. The cutting path intersects an axis 32 of the hole 30. The blade 60 may be moved along the cutting path after the stems of flowers or other vegetation is inserted into the funnel 24 and down through hole 30, with the ends of the stems positioned below the plane of the cutting path. When a user activates the activation device 50, the electromechanically-driven actuation device 40b engages to swiftly move the linear actuator 42b with blade 60 attached along the cutting path. A cutting edge of the blade 60 contacts the stems of the flowers and severs them. Once the cut is complete, the electromechanically-driven actuation device 40b retracts the linear actuator 42b to withdraw the blade 60 to the retracted positioned.

One benefit of using the electromechanically-driven actuation device 40b over a pneumatically-powered actuation device 40a (FIG. 13) as the means for moving the blade 60 is that the length of the cut stroke of the blade 60 can be optimally selected. For example, the connection between the blade 60 and the linear actuator 42b, the connection between the linear actuator 42b and the electromechanically-driven actuation device 40b may be adjusted to ensure that the blade 60 moves fully along the cutting path and does not stop prematurely. This adjustability allows reliability with the cutting edge cutting all flower stems positioned within the hole 30 and not a portion thereof.

Additionally, the electromechanically-driven actuation device 40b ensures consistent cutting power. In comparison, with devices operating with pneumatic power, the initial movement of the cutting blade can lack the power that is desired for clean cutting of the stems when a large quantity of stems are attempted to be cut at once. The electromechanically-driven actuation device 40b, however, can produce the substantially the same cutting power at the blade 60 throughout the cutting process and along the entire cutting path. The electromechanically-driven actuation device 40b may only require approximately 0.5 inches of distance for a cut acceleration and 0.75 inches for a cut deceleration process, providing all remaining movement of the blade 60 at a consistent power. This consistent cutting power ensures a clean cut of the flower stems, which ensure proper functioning of the stem capillaries leading to better hydration which ultimately provides a longer lasting flower for the consumer.

The electromechanically-driven actuation device 40b and linear actuator 42b may provide reliable and quiet operation of the blade 60, and importantly, they may allow the blade 60 to be stopped at any point along the cutting path. For example, the sensor 18 (FIG. 2) may send a signal to the electromechanically-driven actuation device 40b to stop the blade 60 from movement mid-sequence and reverse the blade 60 to the retracted position if a warm object is sensed or if other situations are sensed where injury is likely. The ability to stop the blade 60 mid-sequence provides significant benefits over a pneumatically-controlled blade, which is incapable of being stopped mid-sequence.

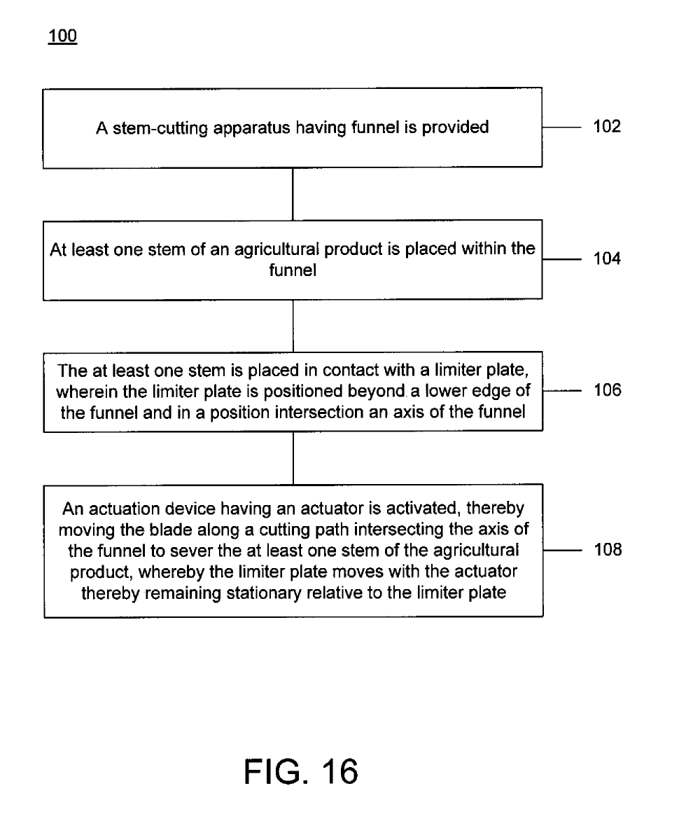

FIG. 16 is a flowchart 100 illustrating a method of making the cutting vegetation with a stem-cutting apparatus in accordance with a fourth exemplary embodiment of the disclosure. It should be noted that any process descriptions or blocks in flow charts should be understood as representing modules, segments, or steps that include one or more instructions for implementing specific logical functions in the process, and alternate implementations are included within the scope of the present disclosure in which functions may be executed out of order from that shown or discussed, including substantially concurrently or in reverse order, depending on the functionality involved, as would be understood by those reasonably skilled in the art of the present disclosure.

As is shown by block 102, a stem-cutting apparatus having a funnel is provided. At least one stem of an agricultural product is placed within the funnel (block 104). The at least one stem is placed in contact with a limiter plate, wherein the limiter plate is positioned beyond a lower edge of the funnel and in a position intersecting an axis of the funnel (block 106). An actuation device having an actuator is activated, thereby moving the blade along a cutting path intersecting the axis of the funnel to sever the at least one stem of the agricultural product, whereby the limiter plate moves with the actuator thereby remaining stationary relative to the limiter plate (block 108). A number of other steps may be included with the method, including steps for any of the structure or functionality disclosed relative to any other embodiment of this disclosure and/or relative to FIGS. 1-15 herein, all of which are considered within the scope of the present disclosure.

For example, the at least one severed stem of the agricultural product may be cleared through a limiter plate hole positioned within the limiter plate, whereby the limiter plate hole is positioned substantially aligned with the axis of the funnel when the actuator is fully extended. For safe use and operation of the stem-cutting apparatus, the activation device may be locked from a potential activation to prevent movement of the blade. Locking the potential activation of the action device may be determined by sensing a heat signature within the funnel, sensing a metallic material within the funnel, activation of a time-out delay switch, and/or activation of a proximity sensor. The actuation device may also be unlocked to allow a potential activation and permit movement of the blade. Unlocking the actuation device may be determined by receiving a valid input passcode on a keypad and/or sensing a predetermined signal within a predetermined radius of a proximity sensor positioned within the stem-cutting apparatus.

It should be emphasized that the above-described embodiments of the present disclosure, particularly, any “preferred” embodiments, are merely possible examples of implementations, merely set forth for a clear understanding of the principles of the disclosure. Many variations and modifications may be made to the above-described embodiment of the disclosure without departing substantially from the spirit and principles of the disclosure. All such modifications and variations are intended to be included herein within the scope of this disclosure and the present disclosure and protected by the following claim.

What is claimed is:

1. A stem-cutting apparatus comprising:
a top plate having a hole positioned therein;
an actuation device positioned proximate to the top plate, wherein the actuation device is activated by an activation device to move an actuator; and
a blade connected to the actuator, wherein the blade is movable along a cutting path, wherein the cutting path intersects an axis of the hole.

2. The stem-cutting apparatus of claim 1, further comprising a funnel positioned at least partially within the top plate, wherein the funnel is positioned substantially concentric with the hole.

3. The stem-cutting apparatus of claim 2, wherein an upper edge of the funnel is positioned substantially aligned with a top surface of the top plate.

4. The stem-cutting apparatus of claim 2, further comprising a main block positioned along a lower edge of the funnel, wherein the actuation device is connected to the main block.

5. The stem-cutting apparatus of claim 4, further comprising a funneled portion within the main block, the funneled portion defining a hole within the main block.

6. The stem-cutting apparatus of claim 4, further comprising a limiter plate positioned substantially parallel to the blade, the limiter plate spaced a predetermined distance from the blade, wherein the blade is positioned between the limiter plate and the main block.

7. The stem-cutting apparatus of claim 6, wherein the limiter plate further comprises a contact portion, a hole portion, and a fastening portion, wherein the hole portion is positioned between the contact portion and the fastening portion, wherein the limiter plate is connected to the actuator at the fastening portion and is movable upon activation of the actuation device, wherein the limiter plate is positioned stationary relative to the blade.

8. The stem-cutting apparatus of claim 7, wherein the blade is positioned substantially overlaying the hole portion of the limiter plate.

9. The stem-cutting apparatus of claim 7, wherein in a non-activated position, the contact portion of the limiter plate intersects the axis of the hole.

10. The stem-cutting apparatus of claim 7, further comprising a limiter plate guide connected to the main block, wherein the limiter plate guide has a slot therein, wherein the contact portion of the limiter plate is movable through the slot.

11. The stem-cutting apparatus of claim 1, further comprising a wiper and sanitizer/disinfectant sponge positioned in contact with a top surface of the blade.

12. The stem-cutting apparatus of claim 1, further comprising a sanitizing solution saturating the wiper and sanitizer/disinfectant sponge, wherein a portion of the sanitizing solution is applied to the top surface of the blade.

13. The stem-cutting apparatus of claim 1, wherein the actuation device further comprises one of:
a pneumatically-powered actuation device having a quantity of compressed gas, wherein a portion of the quantity of compressed gas is released upon activation of the activation device; and
an electrically-powered actuation device having an electric motor, wherein the electric motor is activated upon activation of the activation device.

14. The stem-cutting apparatus of claim 13, wherein the pneumatically-powered actuation device further comprises a quick exhaust system.

15. The stem-cutting apparatus of claim 1, wherein the blade has a cutting edge having a concave shape.

16. The stem-cutting apparatus of claim 1, wherein the blade has a cutting edge having dual bevels.

17. The stem-cutting apparatus of claim 1, further comprising a corrosion resistant coating applied to an exterior surface of the blade.

18. The stem-cutting apparatus of claim 1, wherein the activation device further comprises at least one of: a depressible button; and a foot pedal.

19. The stem-cutting apparatus of claim 1, further comprising at least one cutting hazard sensor in communication with the actuation device, wherein the at least one cutting hazard sensor further comprises:
an sensor positioned to sense a heat signature within the funnel; and
a metal sensor positioned to sense a metallic material within the funnel;

20. The stem-cutting apparatus of claim 1, further comprises a blade movement sensor sensing at least one of a movement of the blade and a position of the blade.

21. The stem-cutting apparatus of claim 1, further comprising an operational control system, wherein the operational control system controls a movement of the blade, wherein the operational control system further comprises at least one of a keypad and a near-field communication (NFC) circuit in communication with the actuation device.

22. The stem-cutting apparatus of claim 21, further comprising an input passcode, wherein the input passcode is entered on the keypad to unlock activation of the actuation device.

23. The stem-cutting apparatus of claim 1, further comprising an operational control system, wherein the operational control system controls a movement of the blade, wherein the operational control system further comprises a time-out delay switch in communication with the actuation device, wherein after a predetermined period of time of inactivity of the actuation device, the time-out delay switch locks activation of the actuation device.

24. The stem-cutting apparatus of claim 1, further comprising an operational control system, wherein the operational control system controls a movement of the blade, wherein the operational control system further comprises a proximity sensor in communication with the actuation device, wherein the proximity sensor unlocks operation of the actuation device upon a predetermined signal sensed within a predetermined radius of the proximity sensor.

25. A stem-cutting apparatus comprising:
a top plate having a hole positioned therein;
a funnel positioned within the hole and extending past a bottom surface of the top plate;
a main block contacting a lower edge of the funnel, the main blocking having a hole therein aligned substantially concentric with the funnel;
an actuation device affixed to the main block having an actuator, wherein the actuator is movable between a retracted position and an extended position;
a blade connected to the actuator, wherein the blade is movable along a cutting path, wherein the cutting path intersects an axis of the funnel; and
a limiter plate connected to the actuator, positioned substantially parallel to the blade, and spaced a predetermined distance from the blade, wherein the limiter plate is stationary relative to the blade, the limiter plate having a limiter plate hole therein, wherein in the retracted position, the limiter plate intersects the axis of the funnel and in the extended position, the axis of the funnel is positioned within the limiter plate hole.

26. A method of cutting stems of agricultural products, the method comprising the steps of:
providing a stem-cutting apparatus having a funnel;
placing at least one stem of an agricultural product within the funnel;
contacting the at least one stem to a limiter plate, wherein the limiter plate is positioned beyond a lower edge of the funnel and in a position intersecting an axis of the funnel; and
activating an actuation device having an actuator, thereby moving the blade along a cutting path intersecting the axis of the funnel to sever the at least one stem of the agricultural product, whereby the limiter plate moves with the actuator thereby remaining stationary relative to the limiter plate.

27. The method of claim 26, further comprising the step of clearing the at least one severed stem of the agricultural product with a limiter plate hole positioned within the limiter plate, whereby the limiter plate hole is positioned substantially aligned with the axis of the funnel when the actuator is fully extended.

28. The method of claim 26, further comprising the step of locking a potential activation of the actuation device to prevent movement of the blade, whereby locking the potential activation of the action device is determined by at least one of:
sensing a heat signature within the funnel;
sensing a metallic material within the funnel;
activation of a time-out delay switch; and
activation of a proximity sensor.

29. The method of claim 26, further comprising the step of unlocking a potential activation of the actuation device to allow movement of the blade, whereby unlocking the potential activation of the actuation device is determined by at least one of:
receiving a valid input passcode on a keypad; and
sensing a predetermined signal within a predetermined radius of a proximity sensor positioned within the stem-cutting apparatus.
